(19) United States
(12) Patent Application Publication
(10) Pub. No.: US 2007/0254191 A1
(43) Pub. Date: Nov. 1, 2007

(54) Magnetic Disk Substrate and Production Method of Magnetic Disk

(75) Inventors: Hiroyuki Machida, Chiba (JP); Katsuaki Aida, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., TOKYO (JP)

(21) Appl. No.: 11/660,956

(22) PCT Filed: Aug. 29, 2005
(86) PCT No.: PCT/JP05/16162

§ 371 Date: Feb. 23, 2007

Related U.S. Application Data
(60) Provisional application No. 60/607,304, filed on Sep. 7, 2004.

(30) Foreign Application Priority Data
Aug. 30, 2004 (JP) 2004-250117

(51) Int. Cl. G11B 5/73; C03B 19/00

(52) U.S. Cl. 428/846; 65/17.1

(57) ABSTRACT

The invention provides a production method for a magnetic disk substrate capable of reducing the number of scratches occurring on the surface of a glass substrate and improving the yield of the glass substrate. When a surface of a magnetic disk substrate is polished by using polishing plates each having a pad, an amorphous or crystallized glass substrate is polished by setting a processing rate to 0.15 μm/min or below and a pad groove width to 2 to 4 mm. Furthermore, a chemical tempered glass substrate is polished by setting the processing rate to 0.15 μm/min or below.

### CROSS-REFERENCES TO RELATED APPLICATIONS

This application is an application filed under 35 U.S.C. §111(a) claiming benefit pursuant to 35 U.S.C. §119(e) of the filing date of Provisional Application No. 60/607,304, filed Sep. 7, 2004, pursuant to 35 U.S.C. §111(b).

### TECHNICAL FIELD

This invention relates to a magnetic disk substrate and a production method of a magnetic disk.

### BACKGROUND ART

Magnetic disk devices have made a remarkable progress, as external storage devices for computers, owing to their superior cost performance ratio and further growth is expected. An aluminum type substrate has been used in the past as a substrate of a magnetic disk which is mounted to the magnetic disk device, but glass substrates, such as chemically tempered glass and crystallized glass, have gradually gained wider application because they have high impact resistance and can be easily made flat. In other words, the aluminum type substrate can easily provide a magnetic disk having excellent magnetic characteristics but involves the problem of flatness because it can suffers plastic deformation during a mechanical process such as polishing. In contrast, the glass substrate can be easily made flat because it has a high surface hardness and does not involve the plastic deformation described above.

Polishing of a glass substrate is conducted after lapping. Polishing is generally conducted as an upper plate and a lower plate are reversely rotated while the glass substrate is clamped between a pair of polishing plates (upper plate and lower plate) each holding a pad. Therefore, various studies have been made to prevent the problem of deterioration of the degree of flatness of the glass substrate, and a method that forms specific grooves on a pad surface has been proposed (Japanese Unexamined Patent Publication (Kokai) No. 9-254021), for example.

### DISCLOSURE OF THE INVENTION

The invention provides a production method for a magnetic disk substrate that reduces the number of scratches occurring on a glass substrate surface when the glass substrate is polished, by using polishing plates each having a pad, and can improve inspection yield of the glass substrate and furthermore, yield of magnetic disks produced from the glass substrates.

To solve the problems described above, the present invention provides the following inventions.
(1) A production method, for a magnetic disk substrate, using polishing of a glass substrate by polishing plates each having a pad, characterized in that an amorphous or a crystallized glass substrate is polished by setting a processing rate to 0.15 μm/min or below and a pad groove width to 2 to 4 mm.
(2) A production method for a magnetic disk substrate using polishing of a glass substrate by polishing plates each having a pad, characterized in that a chemically tempered glass substrate is polished by setting a processing rate to 0.15 μm/min or below.
(3) The production method for a magnetic disk substrate as described in (1), wherein the processing rate is at least 0.05 μm/min.
(4) The production method for a magnetic disk substrate as described in (2), wherein said processing rate is at least 0.05 μm/min.
(5) The production method for a magnetic disk substrate as described in any of (1) through (4), wherein the rate of revolution of the plate is 10 to 40 rpm.
(6) The production method for a magnetic disk substrate as described in any of (1) through (4), wherein the rate of revolution of the plate is 20 to 30 rpm.
(7) A production method of a magnetic disk characterized in that a magnetic recording layer is formed on the magnetic disk substrate as described in any of (1) through (6).
(8) A magnetic disk substrate for a magnetic disk, produced by a production method described in any of (1) through (6).

The invention can provide a production method of a magnetic disk substrate that reduces scratches occurring on a glass substrate surface and can improve the yield of the glass substrates and furthermore, the yield of magnetic disks produced from the glass substrates.

### BEST MODE FOR CARRYING OUT THE INVENTION

Amorphous, chemically tempered or crystallized glass that has generally been used for the magnetic disk substrate can be used as the glass substrate in the invention. Examples are glasses such as soda lime, aluminosilicate, lithium silicate, lithium aluminosilicate, aluminoborosilicate, and so forth. As the chemical tempered glass, glass that is brought into contact with a molten salt at a high temperature to cause ion exchange of alkali ions in the glass with different kinds of alkali ions in the molten salt and is reinforced by the compressive stress is suitable. Examples of the crystallized glass are those which are obtained by re-heating glass under a controlled condition and precipitating and growing a large number of fine crystals. Concrete examples are an Al₂O₃—SiO₂—Li₂O type, a B₂O₃—Al₂O₃—SiO₂—Li₂O type, and so forth. The thickness of such glass substrates is generally selected from the range of about 0.1 to about 2 mm.

When the amorphous or crystallized glass substrate is used in the production method of the magnetic disk substrate according to the invention, polishing is carried out by setting a processing rate to 0.15 μm/min or below and a pad groove width to 2 to 4 mm when the glass substrate is polished by using polishing plates each having a pad. When the amorphous or crystallized glass substrate is used in this way, the pad groove width is set to 2 to 4 mm, so that the draining property and the fluidity of polishing slurry on the pad surface can be optimized. The pad groove is preferably formed in a grid form.

When the chemical tempered glass substrate is used, on the other hand, polishing is carried out by setting the processing rate to 0.15 μm/min or below. In this case, the pad groove need not be disposed.

Such polishing is carried out in the second stage (finish stage) when polishing is carried out in two stages, for example. The processing rate is preferably 0.05 μm/min or above when productivity is taken into consideration. The rate of revolution of the plate is preferably 10 to 40 rpm and further preferably 20 to 30 rpm. Polishing in the invention is generally carried out by abrading the glass substrate surface and the pad surface through an abrasive slurry prepared by dispersing free abrasives in water, etc, by using the polishing plates having a pad. Examples of the abrasives are cerium oxide, zirconium oxide, silicon dioxide, and so forth, but cerium oxide is suitable from the aspect of the polishing speed.

In the invention, polishing is suitably carried out by using the polishing carrier having an inner surface that can come into contact with the outer end face of the glass substrate and is coated with a resin. The resin used for resin coating is a thermoplastic resin such as polyester, polyamide, polyolefin, ABS or polystyrene resin or a thermosetting resin such as epoxy, phenol, unsaturated polyester or polyimide resin, but an epoxy resin is most suitable. Preferably, these resins are not fiber reinforced. The thickness of the resin coating is selected from the range of about 10 μm to about 1 mm.

The resulting magnetic disk substrate is used for the production of a magnetic disk after it is washed and dried in a customary manner. For example, texturing for forming texture grooves in a head traveling direction is first applied to the substrate, whenever necessary. Next, a base film made of a Cr alloy is formed by sputtering on this substrate. A magnetic recording layer made of a Co base alloy is formed to a thickness of about 10 to 100 nm on this base film. A protective film of carbon, or the like, is preferably formed further on this magnetic recording layer to improve corrosion resistance, sliding resistance, etc. Hydrogenated carbon by sputtering or diamond-like carbon by CVD, for example, is formed to a film thickness of about 1 to about 50 nm as this carbon. Perfluoropolyether or a product obtained by esterifying or amidating the terminals of the former is diluted with a solvent and is applied by spraying, dipping, spin coating, etc to a film thickness of about 0.5 to 5 nm as a lubrication layer to the surface of this carbon protective film, and durability, reliability, etc can be further improved.

The magnetic glass substrate obtained by the method of the invention can reduce the scratches occurring on the glass substrate surface and can improve inspection yield of the glass substrate. When the magnetic disk is produced by using this glass substrate, production yield and furthermore, reliability, can be improved.

Though the invention will be explained in further detail with reference to Examples thereof, the invention is not limited to these Examples unless the invention exceeds the gist thereof.

### EXAMPLE 1

A 2.5-in. lithium silicate type crystallized glass substrate was lapped to a predetermined thickness by using a diamond fixed abrasive at a number of revolutions of plates of 15 rpm and a processing pressure of 100 g/cm² (about 7,354 Pa). Next, polishing was carried out by setting a processing rate to 0.10 to 0.15 μm/min and a pad groove width to 3 mm at the number of revolutions of plates of 30 rpm and a processing pressure of 55 g/cm² (about 5,393 Pa) for 40 minutes. After being washed with water, a surfactant and isopropyl alcohol and then dried, the occurrence of scratches of the resulting glass substrates (150 per batch) was inspected through an optical microscope. As a result, a ratio of rejected products due to the occurrence of the scratches was about 1% on an average. On the resulting glass substrate of the approved product were formed serially by sputtering, at a substrate temperature of 200° C., a Cr film as a base layer to 60 nm, a Co₁₃Cr₆Pt₃Ta alloy film as a magnetic recording layer to 20 nm and a diamond-like carbon film as a protective layer to 10 nm. Furthermore, a perfluoropolyether lubrication layer was applied by dipping to a thickness of 3 nm, giving a magnetic disk. This magnetic disk had excellent characteristics.

### COMPARATIVE EXAMPLE 1

A glass substrate was obtained in the same way as in Example 1 with the exception that the processing rate was changed to 0.20 to 30 μm/min and the pad groove width to 1 mm. The ratio of the rejected products due to the occurrence of scratches was about 8 to 9%.

### INDUSTRIAL APPLICABILITY

The invention can reduce the number of scratches occurring on the glass substrate surface and can improve the yield of the glass substrates.

1. A production method for a magnetic disk substrate using polishing a glass substrate by polishing plates each having a pad, characterized in that amorphous or crystallized glass substrate is polished by setting a processing rate to 0.15 μm/min or below and a pad groove width to 2 to 4 mm.

2. A production method for a magnetic disk substrate using polishing a glass substrate by polishing plates each having a pad, characterized in that chemical tempered glass substrate is polished by setting a processing rate to 0.15 μm/min or below.

3. The production method for a magnetic disk substrate according to claim 1, wherein said processing rate is at least 0.05 μm/min.

4. The production method for a magnetic disk substrate according to claim 2, wherein said processing rate is at least 0.05 μm/min.

5. The production method for a magnetic disk substrate according to claim 1, wherein the rate of revolution of said plate is 10 to 40 rpm.

6. The production method for a magnetic disk substrate according to claim 1, wherein the rate of revolution of said plate is 20 to 30 rpm.

7. A production method for a magnetic disk characterized in that a magnetic recording layer is formed on said magnetic disk substrate according to claim 1.

8. A magnetic disk substrate for a magnetic disk, produced by a production method according to claim 1.
